(19) United States
(12) Patent Application Publication
(10) Pub. No.: US 2015/0049670 A1
(43) Pub. Date: Feb. 19, 2015

(54) METHOD FOR OPERATING A NETWORK AND A NETWORK

(71) Applicant: NEC Europe Ltd., Heidelberg (DE)

(72) Inventors: Stefan Schmid, Fellbach (DE); Gottfried Punz, Wien (AT); Toshiyuki Tamura, Tsukubamirai (JP)

(21) Appl. No.: 14/386,537

(22) PCT Filed: Mar. 19, 2013
(86) PCT No.: PCT/EP2013/055726

§ 371 Date: Sep. 19, 2014

(30) Foreign Application Priority Data
Mar. 19, 2012 (EP) 12160204.9

(51) Int. Cl. H04L 12/26; H04W 24/10; H04W 88/16

(52) U.S. Cl. CPC H04L 43/062; H04W 88/16; H04W 24/10
USPC 370/328

(57) ABSTRACT

For allowing a very efficient service marking a method for operating a network, especially a mobile network, is claimed, wherein an ADC, which is co-located in a PCEF or separate in a TDF, detects data flows for reporting data flow-specific information to a control-plane node according to service-specific information received from said control-plane node. The method is characterized in that said service-specific information is provided to the ADC on a service context basis, and the ADC reports the data flow-specific information in the form of a service detection result to the control-plane node according to the service-specific information on a service context basis after having detected a new data flow and checked or identified to what service the new data flow belongs. Further, an according network is claimed, preferably for carrying out the above mentioned method.

The present invention relates to a method for operating a network, especially a mobile network, wherein an ADC, which is co-located in a PCEF or separate in a TDF, detects data flows for reporting data flow-specific information to a control-plane node according to service-specific information received from said control-plane node. Further, the present invention relates to a network, preferably for carrying out the method for operating a network, especially a mobile network, wherein an ADC, which is co-located in a PCEF or separate in a TDF, detects data flows for reporting data flow-specific information to a control-plane node according to a service-specific information received from said control-plane node.

A method for operating a network and an according network in the above sense are generally known from 3GPP (3^{rd} Generation Partnership Project) architecture.

In this document the following acronyms are used:

S-GW Serving Gateway

P-GW PDB Gateway

BBERF Bearer Binding and Event Reporting Function

GTP GPRS Tunneling Protocol

GTP-U GPRS Tunneling Protocol (user plane)

PMIP Proxy Mobile IP

IP-CAN IP Connectivity Access Network

PDN Packet Data Network

SGSN Serving GPRS Support Node

GGSN Gateway GPRS Support Node

EPS Evolved Packet System

MME Mobility Management Entity

PCRF Policy and Charging Rule Function

QoS Quality of Service

NW Network

ADC Application Detection Function

TDF Traffic Detection Function

SD4FCM Service Detection for Filtering, Charging and Monitoring

EPC Evolved Packet Core

CCR Credit Control Request

CCA Credit Control Accept

RAR Re-Authentication Request

RAA Re-Authentication Accept

SID Service Identification

DSCP Differentiated Services Code Point

GERAN GSM Enhanced Radio Access Network

PCEF Policy and Charging Enforcement Function

TFT Traffic Flow Template

SD4SM Service Detection for Service Marking

SDR Service Detection Rule

SMR Service Marking Rule

PDG Packet Data Gateway

ePDG Evolved PDG

OSS Operation Support System

NMS Network Management System

Further, for simplicity the term “gateway” is used in the following for both S-GW and P-GW; in a more narrow meaning it is also used for BBERF in S-GW and PCEF in P-GW. The meaning becomes clear from the context (GTP or PMIP based S5/S8). The term “user context” is used here synonymous with “PDN connection” and “IP-CAN session”.

Further, the following references are cited in the following document:
[1] 3GPP TS 23.401, “General Packet Radio Service (GPRS) enhancements for Evolved Universal Terrestrial Radio Access Network (E-UTRAN) access”
[2] void.
[3] 3GPP TS 23.203, “Policy and charging control architecture”
[4] 3GPP C4-120033 (Work Item Description), “CN aspects of Service

Identification for RRC Improvements in GERAN”
[5] Minutes of CT4 teleconference on Mar. 9, 2012 (distributed on 3GPP CT4 e-mail reflector at Fri, 9 Mar. 2012 14:21:04+0100)
[6] “SIRIG—Evaluation of the methods to signal the new Service Class Indicator within the PS CN”, analysis paper provided as attachment to [5]
[7] 3GPP TS 23.402, “Architecture enhancements for non-3GPP accesses”
[8] 3GPP TS 23.139, “3GPP System-Fixed Broadband Access Network

Interworking; Stage 2”
[9] 3GPP TS 23.234, “3GPP system to Wireless Local Area Network (WLAN) interworking; System description”

For illustration of the present invention a 3GPP network is considered by way of example without limitation of the scope of the invention.

3GPP's Established Bearer Model:

The established model of packet handling in 3GPP networks is based firmly on an IP packet bearer model, which has the following characteristics, see e.g. [1], subclause 4.7.2:
a) the IP packet bearer is defined between the UE and the gateway (GGSN or P-GW), across the radio subsystem and a serving node in the core NW (SGSN or S-GW);
b) the IP packet bearer is set up, maintained and torn down by explicit signaling in the control plane, involving PCRF, MME, radio subsystem;
c) the properties assigned to an IP packet bearer are IP address (type and value), QoS and filter policies and charging parameters;
d) in EPS an IP packet bearer is already established during initial attach—which is called default bearer—and additional ones on demand, whereas in GPRS typically IP packet bearers are established on demand only. Bearers are classified into non-guaranteed bit rate, i.e. best effort, and guaranteed bit rate;
e) there is no defined overload handling, except through release of a bearer.

While this model allows a high degree of control and differentiated handling of applications, it also bears some overhead.

Recently, operators have been alarmed by the steady and strong increase in data traffic—the smart phone issue. It has been found that many data applications run their data transfers on only one best effort bearer, the default bearer. Also, use cases are discussed where the NW is required to react more flexibly to overload. In addition, the operators want to have effective and efficient means to identify services and handle them differently, even if data applications do not explicitly cooperate on the above described bearer model.

Currently Defined Base Functionality for Service Detection in 3GPP's Core NW:

In current 3GPP architecture, see 3GPP TS 23.203 [3], the Application Detection and Control (ADC), function, which may be part of the overall Traffic Detection Function (TDF), has the capability to detect IP flows and report them to PCRF—on a per user context basis—once it has been instructed by the PCRF or is configured to do so. The main purpose of current service detection is to enable monitoring, to influence filtering/charging or to do rerouting. The ADC may be co-located with PCEF or in a standalone TDF separated from the core network gateway which is e.g. GGSN or P-GW. In the following this existing functionality is called “Service Detection for Filtering, Charging or Monitoring” (SD4FCM).

Without loss of generality, in the following an ADC in a separate TDF is assumed throughout and the term “TDF” is used synonymously for that. However, the invention also comprises the case of ADC co-located within PCEF. Without loss of generality we describe here only the EPC case with GTP-based S5/S8, the extension to the other cases, including a TDF co-located with P-GW—also referred to in standards as ADC co-located with PCEF-, is easy, see [1], [3].

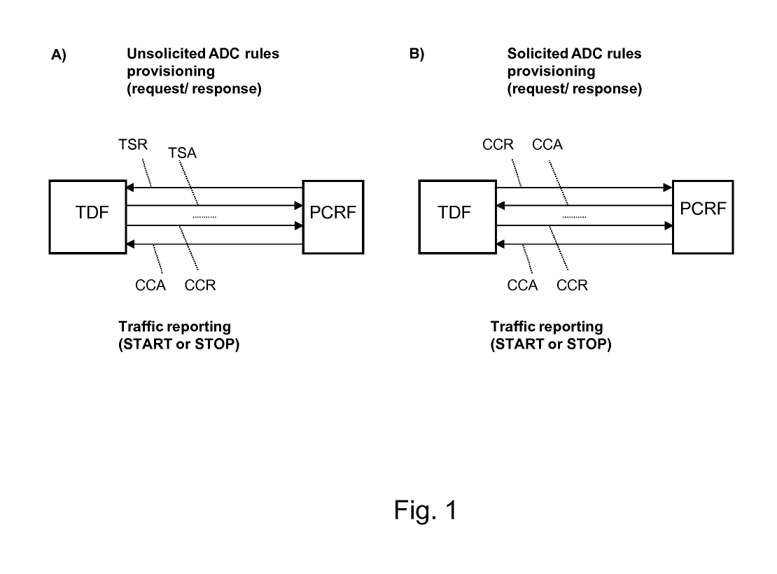

There are service detection rules defined in TDF, either statically provisioned or dynamically signaled from PCRF. The latter ones need to be described by means of Traffic Flow Templates (TFTs), but the former ones may also include more intelligence, e.g. by deeper packet inspection or sophisticated heuristics. The signaling may be solicited—on request of the PCRF—or unsolicited—without prior PCRF request. The difference appears mainly in the type of DIAMETER messages used on the Sd interface. The service detection rules define which application services—characterized by their TFTs—shall be detected. Currently, after detection the subsequent actions may be e.g. redirection, bandwidth limitation or reporting the event of START or STOP of the application, see FIG. 1 showing current signaling for application detection by TDF.

The information provided by PCRF looks like:

ADC-Rule-Definition ::= < AVP Header: 1094 >

| | { ADC-Rule-Name } |
|---|---|
| | [ TDF-Application-Identifier ] |
| | [ Flow-Status ] |
| | [ QoS-Information ] |
| | [ Monitoring-Key ] |
| | [ Redirect-Information ] |
| * | [ AVP ] |

The information reported by TDF looks like:

| | |
|---|---|
| Application-Detection-Information ::= | < AVP Header: 1098 > |
| | { TDF-Application-Identifier } |
| | [ TDF-Application-Instance-Identifier ] |
| | *[ Flow-Information ] |
| | *[ AVP ] |

The event in the CCR has to be set appropriately—to APPLICATION_START or APPLICATION_STOP.

3GPP's Recent Efforts Towards Service Marking in the User Plane:

Specifically for GERAN access, 3GPP has started work on service marking, SIRIG, see [4]. The goal is to mark IP packets with a service identifier (SID) after detecting them to belong to a particular service. Solutions, based on the ADC function have been put forward for the following two cases:
ADC function collocated with P-GW/GGSN and GTP is used on S5/S8: For this case it has been agreed to enhance GTP-U to include the SID for normative specification in 3GPP Rel. 11, see [5].
Standalone TDF or PMIP based S5/S8: For this case it has been proposed to use DSCP marking between TDF and the gateway. Several disadvantages—impact on transport network, lack of available code-points, extensibility, etc.—have been identified for the DSCP solution, see [6]. As a consequence, no agreement has been reached yet to carry out the normative work for this in 3GPP Rel. 11, see [5].

A solution by extending the off-path, PCC-based detection mechanism as described above, for this service marking in GERAN access would be straightforward—still per user session—, but has not been considered for standardization, with the arguments of latency and high signaling effort.

In addition, it is current working assumption in 3GPP that the service marking always happens, regardless of network congestion.

Note: the required number of different SIDs has been proposed to be at maximum 16 in the GERAN—with a maximum number of 10 different handlings—, but it was also discussed that for future extensibility the number should not be limited so much, and more complex deployment scenarios, e.g. roaming, NW sharing, might require more code-points.

It is an object of the present invention to improve and further develop a method for operating a network and an according network for allowing a very efficient service marking easily.

In accordance with the invention, the aforementioned object is accomplished by a method comprising the features of claim 1 and by a network comprising the features of claim 18.

According to claim 1 the method is characterized in that said service-specific information is provided to the ADC on a service context basis, and the ADC reports the data flow-specific information in the form of a service detection result to the control-plane node according to the service-specific information on a service context basis after having detected a new data flow and checked or identified to what service the new data flow belongs.

According to claim 19 the network is characterized in that said service-specific information is provided to the ADC on a service context basis and the ADC is configured for reporting the data flow-specific information in the form of a service detection result to the control-plane node according to the service-specific information on a service context basis after having detected a new data flow and checked or identified to what service the new data flow belongs.

According to the invention it has been recognized that it is possible to allow a very efficient service marking, if in a first step the service detection by an ADC is adapted appropriately. Thus, the ADC will be provisioned with the service-specific information on a service context basis which allows the ADC to report the data flow-specific information in the form of a service detection result to the control plane node according to this service-specific information on a service context basis. In other words, depending on the service-specific information the ADC reports the data flow-specific information to the control-plane node. Contrary to prior art methods this report is performed on a service context basis according to the service-specific information. After having detected a new data flow and checked or identified to what service the new data flow belongs, the ADC decides on the basis of the service-specific information provided to the ADC its further behaviour regarding a report of the service detection result.

This detection and reporting behavior of the ADC forms the basis for a very efficient service marking which could be triggered by the control-plane node depending on the service detection result received by the ADC. Contrary to prior art methods the inventive method will be performed on a service context basis and not on the usual user context basis.

Here and in the whole present application document the general terms “service-specific information” and “service marking information” comprise also the known specific terms and functions “Service Detection Rule (SDR)” and “Service Marking Rule (SMR)”. Thus, in preferred embodiments said specific terms can be used instead of the general terms “service-specific information” or “service marking information”.

With regard to a very efficient service marking—depending on the service detection result or as a reaction to the receipt of the service detection result—the control-plane node could cause an updating of the service-specific information within the ADC and/or an updating of a service marking information within a user-plane gateway which is responsible for service marking. The control-plane node provides a functional entity which could decide to initiate a service marking or not depending on the content of the service detection result or simply as a reaction to the receipt of the service detection result. In a very simple way the control-plane node could simply relay the service detection result to the user-plane gateway without any further policy control.

Within a preferred embodiment the service-specific information could comprise at least one service marking information as being applied within the user-plane gateway for the service marking. In this embodiment the ADC is aware of the same service marking information as being applied within the user-plane gateway. Thus, the ADC could decide to report the service detection result depending on the fact whether the present service marking information is covering the detected new data flow or not.

Within a further preferred embodiment the service marking information could comprise at least one service ID and/or at least one TFT for service marking. Thus, a very reliable decision regarding a possible report of a service detection result to the control-plane node could be performed by the ADC.

Within a further concrete embodiment the ADC does not report a service detection result to the control-plane node, if a TFT for service marking within the service-specific information already covers the new data flow. In this case, a user-plane gateway will already be able to recognize and mark the new data flow and no report by the ADC is necessary.

Within another preferred embodiment the ADC reports a service detection result to the control-plane node, if a TFT for service marking within the service-specific information does not cover the new data flow. In this case, the control-plane node should be informed regarding a new data flow which is not covered by already present information within the user-plane gateway.

With regard to a very simple proceeding the control-plane node could cause the provisioning of an updated and/or extended service marking information to the user-plane gateway. In this way, a very simple report process will be provided.

Regarding a very effective service marking the updated and/or extended service marking information could also be provided to the ADC. Thus, both, the ADC and the user-plane gateway have available the same information.

Within a preferred embodiment service marking information and service detection results could be signaled in an user-unspecific way. Alternatively or additionally the service specific information, preferably signaled in an user-unspecific way, could be combined with user specific policy information, preferably signaled in an user-specific session.

With regard to a very efficient and comfortable service marking and for controlling on a per-user/UE basis whose traffic is subject to service marking, the control-plane node could indicate in a policy information to the user-plane gateway, if a corresponding traffic should be subject to service marking or not.

With regard to saving of network resources and for simplifying service marking a service marking could be performed only for users in a particular radio access or for a predetermined limited time. A simple realization of this service marking only for users in a particular radio access or for a predetermined limited time could be achieved by providing additional policy information from the control-plane node to the user-plane gateway in a very simple way.

Further, with regard to a very efficient service marking a service detection for service marking (SD4SM) could only be activated, when a data connection or PDN connection suffered or suffers a predefined level of network congestion. If the predefined level of network congestion is not reached, no service marking seems to be necessary.

In a very simple way the service detection result could comprise at least one service marking information. In this case, the ADC could provide the service detection result in the form of at least one service marking information and/or TFT and could report this service detection result to the control-plane node according to the service-specific information.

The method according to the present invention could be realized by various functional entities. Within preferred embodiments the control-plane node could be a PCRF or a NMS or OSS or could be provided by a PCRF, NMS or OSS. Further, the user-plane gateway could be a P-GW, S-GW, GGSN, PCEF or BBERF. The respective network could be a GPRS/EPS or WiMAX network.

Important Aspects of the Present Invention are Summarized as Follows:

The present invention provides:
Service-based/centric signalling of service-marking rules/TFTs from a traffic detection function, e.g. ADC or TDF, via a control-plane node, e.g. PCRF, to a user-plane gateway, e.g. P-GW/S-GW/GGSN, responsible for the service marking
   Compared to existing PCC signalling, service-based/centric signalling only has one context per service—rather than one context per user/UE—and is not bound to a user context. This requires dedicated messages on Gx, Gxx and Td interfaces.
New types of Service Detection Rules for “Service Marking” (SD4SM) rather than for filtering, monitoring and charging of user flows.
Efficient signalling of new/updated SMRs—by signalling only when the enforced service-marking TFTs need to be extended; this is enabled by providing the service-marking TFTs to the ADC or TDF as part of the SDRs
Extension of the existing PCC rules, signalled during bearer setup, to include an indication that informs the P-GW/S-GW/GGSN that service marking rules should be applied to this bearer
   this allows the packet gateway to only apply the service marking information or SMR on the respective bearers
Service Marking (SD4SM) can be activated only if necessary, e.g. considering network conditions.

Important aspects of the invention include the provision of a flexible, future proof and efficient solution for service detection, signaling and marking for standalone TDF and/or PMIP-based S5/S8.

Advantages of this approach according to the invention are as follows:
the signaling load required for the service marking is minimized;
the number of contexts is kept to the number of services that need to be detected—and not per user;
the probability that packets are not yet marked correctly is much lower—compared to an off-path solution based on signaling per user context—, since only the first packets of a new service may “slip through” as a result of the signaling delay between TDF via PCRF to PCEF/BBERF;
PCRF involvement allows to include further policy decisions compared to solutions relying on service marking in TDF.

Note: This approach basically addresses all the disadvantages highlighted regarding the Solution II.C in the CT4 discussion paper [6].

There are several ways how to design and further develop the teaching of the present invention in an advantageous way. To this end, it is to be referred to the patent claims subordinate to patent claim 1 on the one hand and to the following explanation of preferred examples of embodiments of the invention, illustrated by the drawing on the other hand. In connection with the explanation of the preferred embodiments of the invention by the aid of the drawing, generally preferred embodiments and further developments of the teaching will we explained. In the drawings

FIG. 1 is showing schematically a current signaling for application detection by TDF,

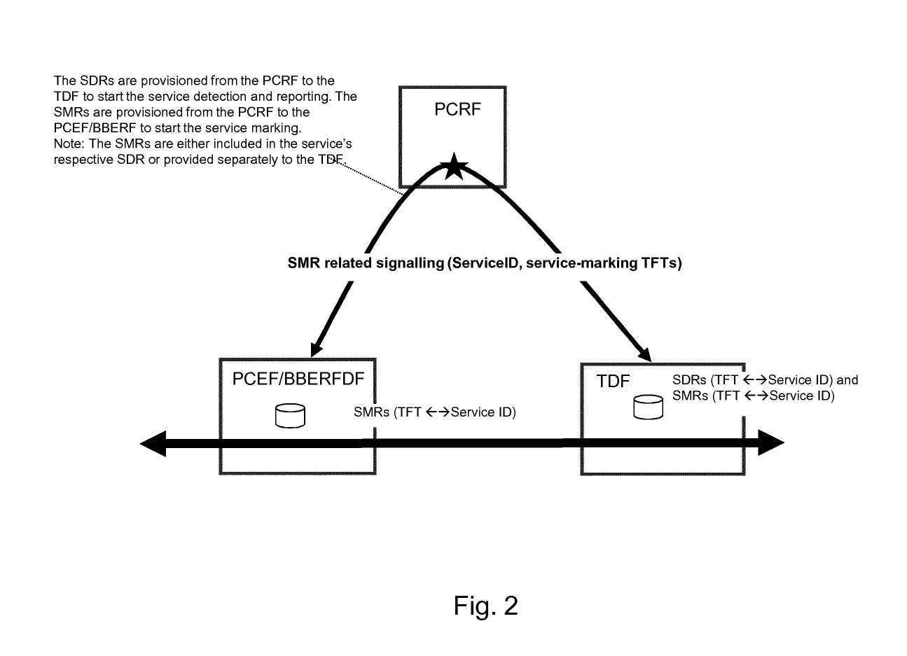

FIG. 2 is illustrating an embodiment of an overall concept for SD4SM according to the invention,

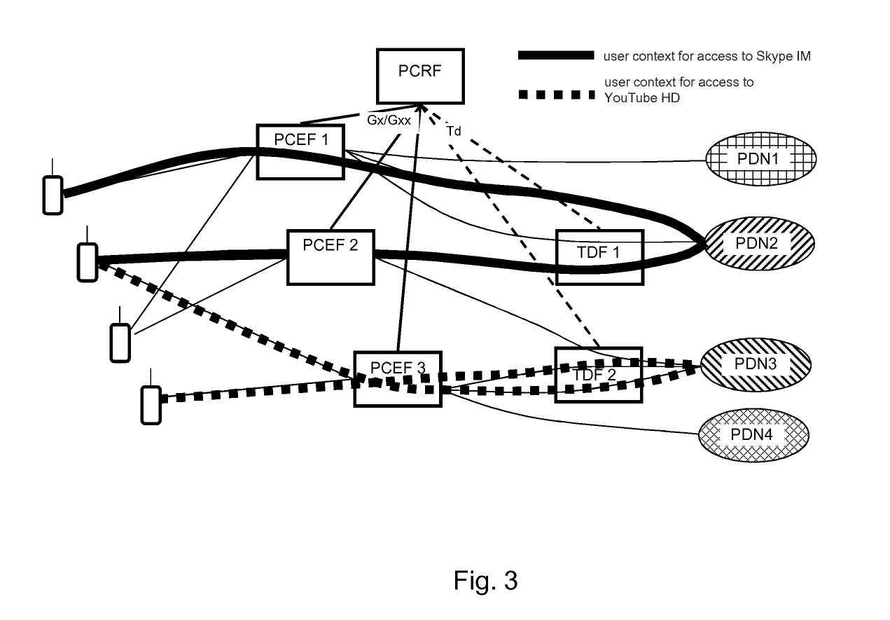

FIG. 3 is illustrating a multiplicity of gateways and TDFs,

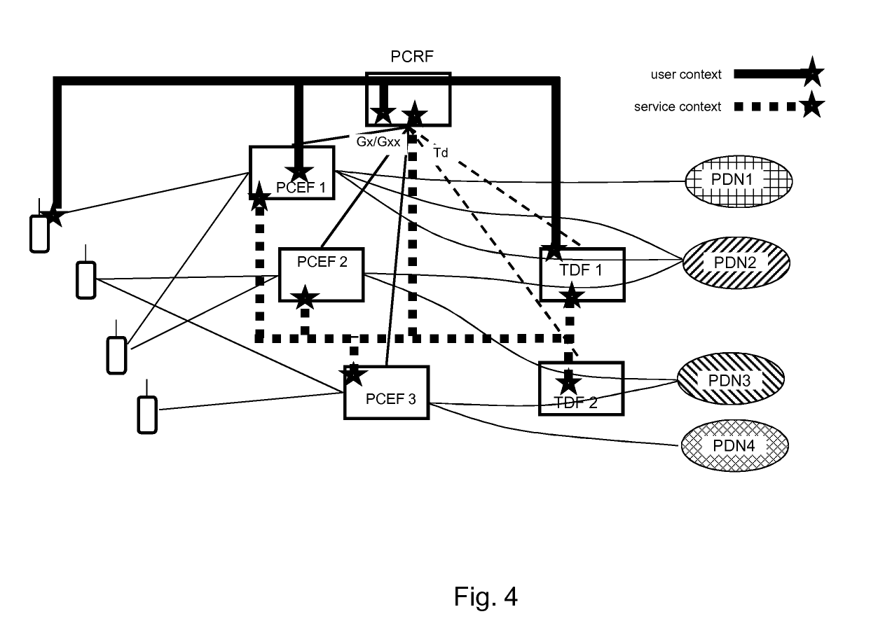

FIG. 4 is illustrating user context and service context across the network,

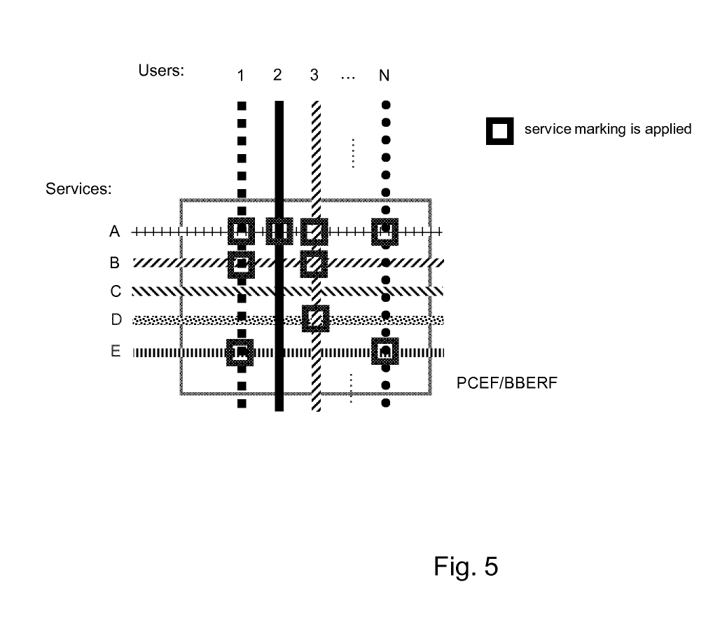

FIG. 5 is illustrating a possible combination of service context and user context for service marking in a logical view and

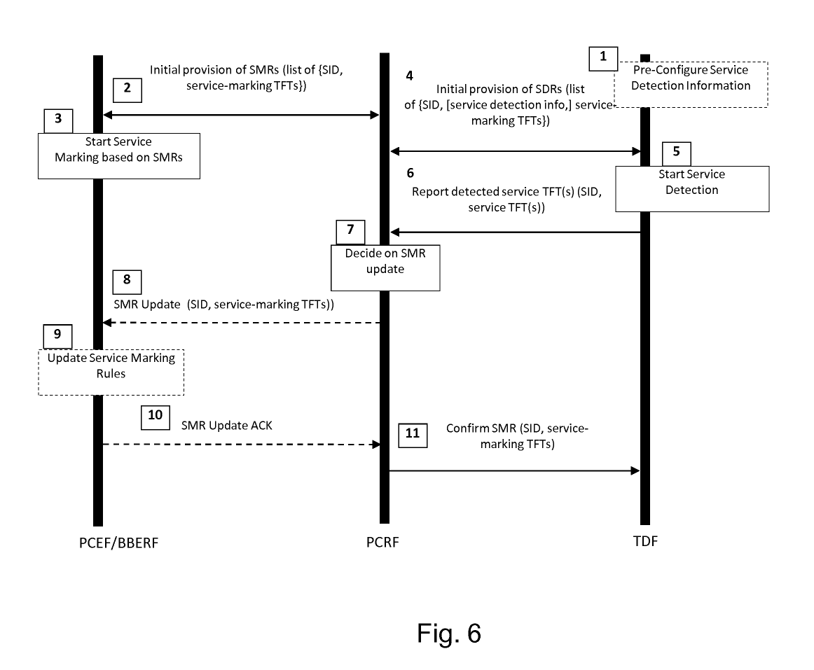

FIG. 6 is showing a possible signaling flow for an embodiment of SD4SM.

Embodiments of the invention propose a solution that enables efficient service marking with low-signaling cost in the PCEF (P-GW/GGSN) or BBERF (S-GW) characterized by the following:
new service-based reporting/signaling between the TDF and the PCRF,
new service-based marking rules/signaling between the PCRF and the PCEF/BBERF.

So, if the operator wants to enable service marking, the TDF is provisioned with service-specific aggregate TFTs for those services for which service marking shall occur. A key differentiator between the current application detection capability SD4SM as described in the above problem statement and the new “Service Detection for Service Marking” (SD4SM) is that the former is done on user context, i.e. per-user/UE, basis, while the latter is done on a service context, i.e. per service, basis. For example, the SD4FCM is triggered by the PCRF session establishment of a new PDN connection/bearer, while the latter is triggered by the configuration of a new service to be marked, i.e. in terms of PCRF sessions only on session is needed per TDF and per PCEF/BBERF, or one separate session per service to be marked, but NOT one per UE. The overall concept of SD4SM is given in FIG. 2.

Again, the TDF has the capability/intelligence to detect various applications/services based on policies/filters that are pre-configured at the TDF or also dynamically provisioned by the TDF.

When the PCRF instructs the TDF to carry out “Service Detection for Service Marking” (SD4SM), it also provides the TDF with the current Service Marking Rules (SMR), i.e. the Service ID and service-marking TFTs, as they are applied in the PCEF/BBERF for the service marking. So when the TDF detects a new flow, it checks to what service it belongs. Once the Service ID has been identified, it checks if the current service-marking TFTs of the respective SMR already cover this new flow. I.e. it checks if the current SMR used in the PCEF/BBERF would already trigger the service marking of this new flow. If yes, no further action will be needed. If no, the TDF will inform the PCRF about the service detection results, i.e. the TDF will signal the flow template of this new flow, or the extended service-marking TFTs, to the PCRF. The PCRF in turn checks if this new flow should indeed be marked—or if the extended service-marking TFT is acceptable—and if so, it will trigger a SMR update towards the PCEF/BBERF, with the updated/extended service-marking TFT. In order to allow the PCRF to control on a per-user/UE basis whose traffic is subject to service marking, the PCRF may also indicate in an extended/enhanced PCC rule if the corresponding traffic, i.e. the traffic belonging to this bearer, should be subject to service marking or not. The updated/extended SMR will also be provided to the TDF, so that in turn it is aware of the service-marking TFTs used by the PCEF/BBERF.

Alternatively, the PCRF may also simply relay an updated/extended SMR—based on the service detection results in the TDF—to the PCEF/BBERF—without any additional policy control. In this case, the TDF maintains the “master-copy” of the SMR and hence does not need to be updated with the latest SMR.

In this concept the PCRF plays a central role, as the node with central control and synchronization across the whole operator network. This concept especially supports efficient updating of SMRs and SDRs—e.g. with a new IP address, if an additional server has become available and is used for a service—, which is also the major effort to be expected in actual deployments, and not so much the effort for creation/configuration/distribution of completely new SMRs and SDRs.

In addition, if network congestion information is available, it is possible to activate the SD4SM only when a PDN connection suffered network congestion. If the PCRF decides not to perform the SD4SM, then the PCRF instructs both TDF and PCRF/BBERF not to perform the SD4SM. This treatment helps the TDF to reduce traffic processing significantly, due to adopting an “activate on demand” type of approach.

Additional notes:
1. the SD4SM concept works independently of any already defined service detection, e.g. SD4FCM, as mentioned above.
2. This invention generally does not specify the details of the marking information itself and how the mark is applied on the user plane packets.

Embedding in Network Deployment:

The aspect of multiplicity of gateways and TDFs as well as traffic routing via TDFs is illustrated in FIG. 3. For simplicity only one PCRF and only the PCEFs are shown, but the extension to multiple PCRFs and inclusion of BBERFs is straightforward.
1. Traffic for one and the same PDN/APN may or may not pass a TDF. The separation can be done e.g. according to IP address ranges.
2. Traffic for one and the same service is typically distributed over several gateways.
3. One UE typically uses several services; its traffic may be distributed over several PCEFs but only one BBERF.

The scopes of user context, i.e. the existing concept, and service context—and thus related policies, i.e. the new concept—is illustrated in FIG. 4. For simplicity only one PCRF and only the PCEFs are shown, but the extension to multiple PCRFs and inclusion of BBERFs is straightforward. It is visible that a service context needs to be synchronized across all gateways, PCRFs and TDFs; however, their number is small, e.g. on the order of a 2 or 3 digit number. In contrast, a user context is synchronized across UE, gateway, PCRF and TDF; their number is on the order of millions. In both cases we neglect RAN in this description, but it is the intention that RAN uses the information on the service, if available, e.g. by service marking.

From this view it is clear that signaling for service marking, i.e. managing service contexts, must be quite different from signaling for PDN connection handling, i.e. managing user contexts.

It has to be noted that the service context concept and the user context concepts are not exclusive to each other; rather, they can be used in conjunction. E.g. it can be a goal of the operator to exempt certain “gold” users from service marking. This can be achieved by providing additional policy information from PCRF to PCEF/BBERF in the user context related signaling and combining it with the base service marking policy. In a more general way such a combination of user context and service context related information can be used not only for service marking, but also for a more sophisticated handling of traffic in the PCEF/BBERF. Similarly, the marking can be performed only for users in a particular radio access, e.g. GERAN, or for a limited time. This can be achieved by providing additional policy information from PCRF to PCEF/BBERF in user-unspecific signaling and combining it with the base service marking policy.

In FIG. 5 the logical view of the combinational principle for service marking is illustrated in an example.

Variant for PMIP-based S5/S8:

3GPP's PMIP-based architecture according to [7] is already covered in the above proposal, represented by BBERF with Gxx interface.

However, for an IPv6 transport network a variant is proposed where the service marking information is still signaled to PCEF, via Gx interface. The marking is then applied by PCEF and transported in the outer PMIP tunnel, by virtue of the IPv6 flow label, which is anyway not used.

Procedural and Message Details:

A possible signaling flow is shown in FIG. 6:

These are the steps for one representative entity of TDF, PCRF and PCEF/BBERF:
1. Optional: Pre-configure the service detection information/intelligence on the TDF, i.e. instruct the TDF how to detect services—e.g. based on TFTs and/or DPI policies.
2. If service marking is enabled, a general Gx session is established between PCRF and PCEF/BBERF, independent of any user context. The PCRF provides an initial list of services to be marked, by virtue of a list of Service Marking Rules, i.e. Service IDs [SID] plus service-marking TFTs. The PCEF/BBERF installs SMR in its DB and reports back the success. The PCRF also instructs the PCEF/BBERF whether SMR is required or not, typically based on network congestion information for the corresponding PDN connection.
3. The PCEF/BBERF starts marking user plane packets matching one of the service-marking TFTs with the corresponding SID. In order to allow the PCRF to control on a per-user/UE basis whose traffic is subject to service marking, the PCRF may also indicate in an extended/enhanced PCC rule if the corresponding traffic, i.e. the traffic belongs to this bearer, should be subject to service marking or not.
4. If SD4SM is enabled, a general Sd session is established between PCRF and TDF, independent of any user context. The PCRF provides an initial list of services to be detected, i.e. Service Detection Rules. As part of the SDRs, the PCRF may provide the service detection information/intelligence for the services to be detected. The SDRs also include the service-marking TFTs for each service to be detected. The TDF adds the SDRs in its DB and reports back the success. In addition, the PCRF may also instruct the TDF with SDR(s)/SMR(s) for a particular UE or set of UEs, typically based on network congestion information for UEs.
5. The TDF starts to detect service data flows when required.
6. Once the TDF detects a new service flow which is not yet matched by the SMR, i.e. service-marking TFTs, the TDF reports this to the PCRF. In this step it either reports the detected service TFT or service-marking TFT of the new service flow or updates the whole service marking TFT set of the corresponding service.
7. The PCRF decides how to proceed with the proposed service-marking TFT update.
8. If the PCRF decides to mark the newly detected service, it will update the

SMRs by sending an SMR Update to the PCEF/BBERF.
9. The PCEF/BBERF adds the new SMR to its DB and starts applying those new rules.
10.The PCEF/BBERF acknowledges the SMR update to the PCRF.
11.The PCRF confirms the currently applied SMR, i.e. service-marking TFTs, with the TDF.

If more than one of the entities TDF, PCRF and PCEF/BBERF are deployed, the signaling has to be replicated correspondingly, based on network configuration and/or operator policy.

Time or load dependent en/disabling of service marking would require additional, though simpler message flows. This can be derived from the given message flow in a straightforward manner.

Extensions:

The following extensions are possible in a straightforward manner and are thus to be seen included in this invention, although not described in detail here:
For some roaming cases signaling via reference point S9 has to be used in conjunction with reference points Gx/Gxx/Sd, see subclause 5 of [3].
The equivalent concept and procedures are also valid for a—generic—non-3GPP access integrated within the 3GPP network, in which case reference points Gxa and Gxb can be used accordingly, see [7]; PCEF and/or BBERF or equivalent functionality is then located at an entity in non-3GPP access or in ePDG.
The equivalent concept and procedures are also valid for a fixed broadband access integrated in the 3GPP network, in which case reference points Gxb* and S9a can be used, see [8]. PCEF and/or BBERF or equivalent functionality is then located at an entity in the fixed broadband access or in ePDG.
The equivalent concept and procedures are also valid for I-WLAN, see [9]; PCEF functionality is then located in PDG.
The functionality assigned to the PCRF in this example could also be provided by another functional entity in the mobile network, e.g. a new entity or the NMS/OSS.
Although the invention is described only for 3GPP defined GPRS/EPS networks, the same concept could also be applicable in other mobile networks, e.g. WiMAX.

The present invention provides the possibility of realizing a method and network or system for efficient service detection, signaling or reporting and marking via a control-plane node. The terms signaling, reporting and sending can be understood synonymously within the present document.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for operating a network, especially a mobile network, wherein an ADC, which is co-located in a PCEF or separate in a TDF, detects data flows for reporting data flow-specific information to a control-plane node according to service-specific information received from said control-plane node, characterized in that said service-specific information is provided to the ADC on a service context basis, and the ADC reports the data flow-specific information in the form of a service detection result to the control-plane node according to the service-specific information on a service context basis after having detected a new data flow and checked or identified to what service the new data flow belongs.

2. A method according to claim 1, wherein depending on the service detection result or as a reaction to the receipt of the service detection result the control-plane node causes an updating of the service-specific information within the ADC and/or an updating of a service marking information within a user-plane gateway which is responsible for service marking.

3. A method according to claim 2, wherein the service-specific information comprises at least service marking information as being applied within the user-plane gateway for the service marking.

4. A method according to claim 3, wherein the service marking information comprises at least one Service ID and/or at least one TFT for service marking.

5. A method according to claim 1, wherein the ADC does not report a service detection result to the control-plane node, if a TFT for service marking within the service-specific information already covers the new data flow.

6. A method according to claim 1, wherein the ADC reports a service detection result to the control-plane node, if a TFT for service marking within the service-specific information does not cover the new data flow.

7. A method according to claim 2, wherein the control-plane node causes the provisioning of an updated and/or extended service marking information to the user-plane gateway.

8. A method according to claim 7, wherein the updated and/or extended service marking information will also be provided to the ADC.

9. A method according to claim 2, wherein service marking information and service detection results are signalled in an user-unspecific way.

10. A method according to claim 2, wherein service-specific information, preferably signalled in an user-unspecific way, can be combined with user specific policy information, preferably signalled in an user-specific session.

11. A method according to claim 2, wherein for controlling on a per-user/UE basis whose traffic is subject to service marking, the control-plane node indicates in a policy information to the user-plane gateway, if a corresponding traffic should be subject to service marking or not.

12. A method according to claim 1, wherein a service marking will be performed only for users in a particular radio access or for a predetermined limited time.

13. A method according to claim 12, wherein the service marking only for users in a particular radio access or for a predetermined limited time will be achieved by providing additional policy information from the control-plane node to the user-plane gateway.

14. A method according to claim 1, wherein a service detection for service marking (SD4SM) will only be activated, when a data connection or PDN connection suffered or suffers a predefined level of network congestion.

15. A method according to claim 1, wherein the service detection result comprises at least one service marking information.

16. A method according to claim 1, wherein the control-plane node is or is provided by a PCRF (Policy and Charging Rule Function) or a NMS or OSS.

17. A method according to claim 2, wherein the user-plane gateway is a P-GW, S-GW, GGSN, PCEF or BBERF.

18. A method according to claim 1, wherein the network is a GPRS/EPS or WiMAX network.

19. A network, preferably for carrying out the method for operating a network, especially a mobile network, according to claim 1, wherein an ADC, which is co-located in a PCEF or separate in a TDF, detects data flows for reporting data flow-specific information to a control-plane node according to a service-specific information received from said control-plane node, characterized in that said service-specific information is provided to the ADC on a service context basis and the ADC is configured for reporting the data flow-specific information in the form of a service detection result to the control-plane node according to the service-specific information on a service context basis after having detected a new data flow and checked or identified to what service the new data flow belongs.
